(19) United States
(12) Patent Application Publication
(10) Pub. No.: US 2026/0121101 A1
(43) Pub. Date: Apr. 30, 2026

(54) Battery Manufacturing Apparatus

(71) Applicant: SK On Co., Ltd., Seoul (KR)

(72) Inventor: Jae Sung BAE, Daejeon (KR)

(21) Appl. No.: 19/368,000

(22) Filed: Oct. 24, 2025

(30) Foreign Application Priority Data
Oct. 28, 2024 (KR) 10-2024-0148381

(51) Int. Cl. H01M 10/04; H01M 50/105

(52) U.S. Cl. CPC H01M 10/0404; H01M 50/105

(57) ABSTRACT

The present disclosure relates to a battery manufacturing apparatus for sealing a sealing region in a battery cell, the battery cell comprising a case forming a receiving space for receiving an electrode assembly, and the sealing region formed on a flange portion formed along a circumference of the receiving space, the battery manufacturing apparatus comprising: a first sealing bar and a second sealing bar disposed to face each other across the sealing region; a first sealing surface among one surface of the first sealing bar, the first sealing surface facing the sealing region; a second sealing surface among one surface of the second sealing bar, the second sealing surface facing the sealing region and the first sealing surface; a film-shaped first heating portion disposed on the first sealing surface; and a film-shaped second heating portion disposed on the second sealing surface.

### CROSS-REFERNECE TO RELATED APPLICATION

The present application claims priority under 35 U.S.C. § 119(a) to Korean patent application number 10-2024-0148381 filed on October 28, 2024, in the Korean Intellectual Property Office, the entire disclosure of which is incorporated by reference herein.

### BACKGROUND OF THE INVENTION

### 1. Field

Embodiments of the present disclosure relate to a battery manufacturing apparatus. More particularly, the present disclosure relates to a battery manufacturing apparatus capable of improving quality of a battery cell.

### 2. Description of the Related Art

A conventional battery manufacturing apparatus seals an exterior material by heating a sealing region of the exterior material of a battery cell, in such a manner that a sealing bar including a heater and a temperature sensor is spaced apart by a predetermined distance from the sealing region.

However, since the sealing bar is positioned spaced apart from the sealing region, precise temperature control through the heater and the temperature sensor may be difficult. In addition, due to local non-uniform heating, sealing defects occur, which may not only cause a slip phenomenon in a portion of layers of the exterior material formed of a plurality of layers, but also cause insulation breakdown of the battery cell due to spot fusion of the exterior material.

### SUMMARY OF THE INVENTION

According to one aspect of the present disclosure, an object is to improve quality of a battery cell.

According to another aspect of the present disclosure, an object is to improve manufacturing efficiency of a battery cell.

According to still another aspect of the present disclosure, an object is to seal a case (or exterior material) of a battery cell at a desired temperature in a sealing process of the battery cell.

According to yet another aspect of the present disclosure, an object is to seal the case (or exterior material) of a battery cell in various patterns.

Meanwhile, the present disclosure can be widely applied to fields of green technology such as Electric Vehicles, Battery Charging Stations, Energy Storage Systems (ESS), and other battery-utilizing Photovoltaics and Wind Power. In addition, the present disclosure can be used in eco-friendly mobility including Electric Vehicles and Hybrid Vehicles for preventing climate change by suppressing air pollution and greenhouse gas emissions.

As a technical means to achieve the technical objects, a battery manufacturing apparatus for manufacturing a battery cell comprising a case forming a receiving space for receiving an electrode assembly, a flange portion formed along a circumference of the receiving space in the case, and a sealing region sealing at least a portion of the flange portion, the battery manufacturing apparatus according to the present disclosure may include: a first sealing bar and a second sealing bar disposed to face each other across the sealing region so as to contact the sealing region and extending along a predetermined extending direction parallel to one side of the receiving space; a first sealing surface among one surface of the first sealing bar, the first sealing surface facing the sealing region; a second sealing surface among one surface of the second sealing bar, the second sealing surface facing the sealing region and the first sealing surface; a film-shaped first heating portion disposed on the first sealing surface; and a film-shaped second heating portion disposed on the second sealing surface.

In one embodiment, the first heating portion may include: a first heater disposed in a predetermined first region on the first sealing surface; and a second heater and a third heater respectively disposed in a second region and a third region formed on the first sealing surface across the first region.

In addition, the first heater, the second heater, and the third heater may be respectively extended along the extending direction.

In addition, the first heater, the second heater, and the third heater may be respectively provided in a plurality.

In one embodiment, the first heater, the second heater, and the third heater may be heated at different temperatures.

In another embodiment, the first heating portion may include: a first heater disposed in a predetermined first region on the first sealing surface; and a second heater disposed in a second region located closer to the receiving space than the first region on the first sealing surface.

In addition, the first heating portion may include: a first heater disposed in a predetermined first region on the first sealing surface; and a second heater disposed in a second region located farther from the receiving space than the first region on the first sealing surface.

In addition, the first heater and the second heater may be respectively extended along the extending direction.

In addition, the first heater and the second heater may be respectively provided in a plurality.

In addition, the first heater and the second heater may be heated at different temperatures.

In still another embodiment, the first heating portion may include: a first heater disposed in a predetermined first region on the first sealing surface; and a second heater disposed in a second region located along a circumference of the first region on the first sealing surface.

Meanwhile, the battery manufacturing apparatus according to the present disclosure may further include: a first temperature sensor disposed on the first sealing bar and configured to sense a temperature of the first heating portion; and a second temperature sensor disposed on the second sealing bar and configured to sense a temperature of the second heating portion.

In one embodiment, the first temperature sensor and the second temperature sensor may be thermocouples.

In one embodiment, the first temperature sensor may be inserted into the first sealing bar spaced apart by a predetermined distance from the first sealing surface, and the second temperature sensor may be inserted into the second sealing bar spaced apart by the predetermined distance from the second sealing surface.

Meanwhile, a battery manufacturing apparatus for manufacturing a battery cell comprising a case forming a receiving space for receiving an electrode assembly, a flange portion formed along a circumference of the receiving space in the case, and a sealing region sealing at least a portion of the flange portion, the battery manufacturing apparatus according to the present disclosure may include: a first sealing bar and a second sealing bar disposed to face each other across the sealing region so as to contact the sealing region; a first sealing surface among one surface of the first sealing bar, the first sealing surface facing the sealing region; a second sealing surface among one surface of the second sealing bar, the second sealing surface facing the sealing region and the first sealing surface; and a film-shaped heating portion disposed on at least one sealing surface of the first sealing surface or the second sealing surface.

Meanwhile, a battery manufacturing apparatus for manufacturing a battery cell comprising a case forming a receiving space for receiving an electrode assembly, and a flange portion formed along a circumference of the receiving space in the case, the battery manufacturing apparatus according to the present disclosure may include: a first bending body and a second bending body disposed to contact the flange portion across the flange portion to bend at least a portion of the flange portion; wherein the first bending body and the second bending body respectively comprise: a block body movable toward the flange portion; a unit body disposed in a direction farther from the receiving space than the block body and movable toward the flange portion; a film-shaped first heating portion disposed on a block contact surface among one surface of the block body, the block contact surface contacting the flange portion; and a film-shaped second heating portion disposed on a unit contact surface among one surface of the unit body, the unit contact surface contacting the flange portion.

According to one embodiment of the present disclosure, quality of a battery cell can be improved.

According to another embodiment of the present disclosure, manufacturing efficiency of a battery cell can be enhanced.

According to still another embodiment of the present disclosure, a case (or exterior material) of a battery cell can be sealed at a desired temperature in a sealing process of the battery cell.

According to yet another embodiment of the present disclosure, a case (or exterior material) of a battery cell can be sealed in various patterns.

### BRIEF DESCRIPTION OF THE DRAWINGS

FIG. 1 is an example of a battery cell according to the present disclosure.

FIG. 2 illustrates one step of a manufacturing process of a battery cell according to the present disclosure.

FIGS. 3A to 3E illustrate steps after the one step shown in FIG. 2.

FIG. 4 illustrates an example of a battery manufacturing apparatus according to the present disclosure.

FIGS. 5A to 5D illustrate various embodiments of a heating portion.

FIG. 6 illustrates a control block diagram of a battery manufacturing apparatus according to the present disclosure.

FIG. 7 illustrates another example of a battery manufacturing apparatus according to the present disclosure.

### DETAILED DESCRIPTION

Hereinafter, preferred embodiments of the present disclosure will be described in detail with reference to the accompanying drawings. The configuration of the apparatus or the control method to be described below is merely for explaining embodiments of the present disclosure, and is not intended to limit the scope of the present disclosure, and the same reference numerals used throughout the specification denote the same components.

Specific terms used in the present specification are merely for convenience of explanation and are not used to limit the illustrated embodiments.

In the present specification, the terms battery, secondary battery, and cell all mean a battery cell capable of charging and discharging.

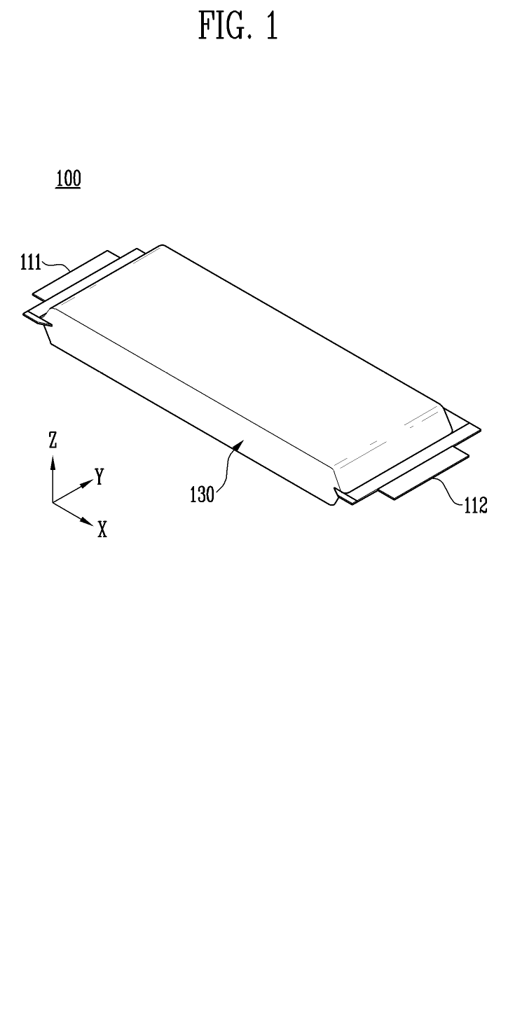

FIG. 1 is an example of a battery cell according to the present disclosure.

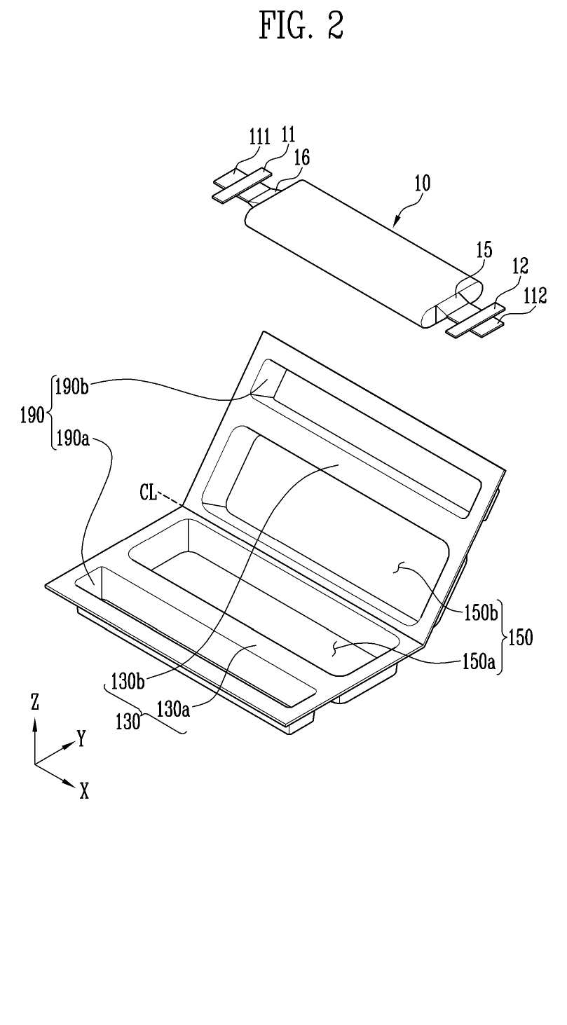

The battery cell 100 according to the present disclosure includes a case 130 accommodating an electrode assembly 10 (see FIG. 2) therein, and lead tab portions 111 and 112 electrically connected to the electrode assembly 10 and protruding outward from the case 130.

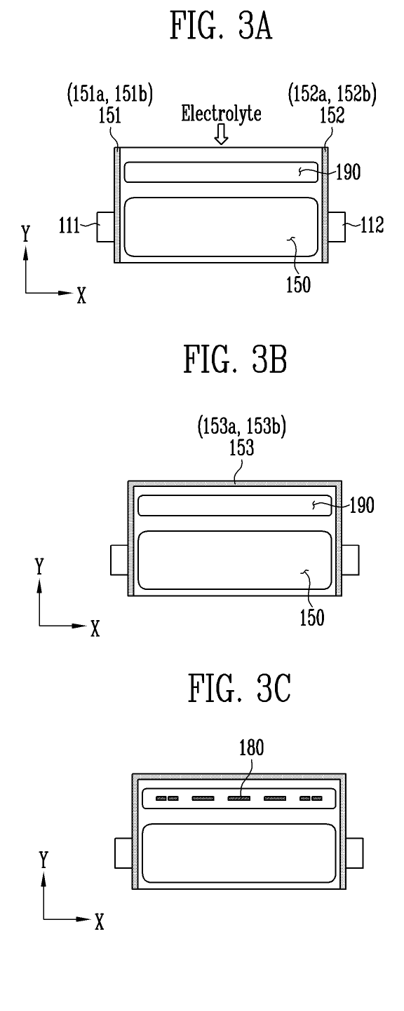

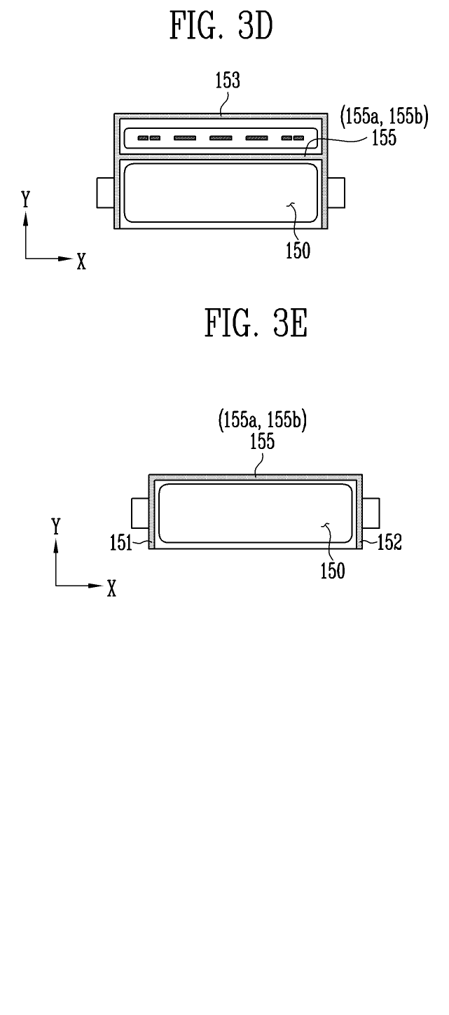

The case 130 may be formed of a flexible material and may include the electrode assembly 10 therein and an electrolyte EL (see FIG. 3A) in which the electrode assembly is immersed. Meanwhile, the case 130 may have all opened portions sealed in order to prevent the electrolyte from leaking to the outside.

Meanwhile, in order to activate the battery cell 100, a manufacturing process of the battery cell needs to charge and discharge the battery cell 100 being manufactured. However, during a charging and discharging process (or an initial charging and discharging process) of the battery cell 100 being manufactured, gas may inevitably be generated from the electrolyte. Since failure of the battery cell may be caused if the gas generated inside the case 130 is not removed, a process of removing the gas is regarded as an essential process in the manufacturing process of the battery cell.

That is, the manufacturing process of the battery cell may perform a degassing process for removing the gas. Meanwhile, in order to efficiently remove the gas in the degassing process, a space for capturing the gas inside the battery cell 100 will be required.

FIG. 2 illustrates one step of a manufacturing process of a battery cell according to the present disclosure.

Specifically, FIG. 2 illustrates one step of a manufacturing process of manufacturing the battery cell 100, in which degassing is considered after capturing gas generated inside the battery cell 100.

Referring to FIG. 2, the electrode assembly 10 may be disposed inside the case 130.

The electrode assembly 10 may be formed by sequentially stacking a positive electrode, a separator, and a negative electrode. The positive electrode and the negative electrode may be separated by the separator to prevent them from contacting each other.

The battery cell 100 may include lead tab portions 111 and 112 connected to the electrode assembly 10 and protruding outward. The electrode assembly 10 may be inserted into the case 130 after being connected to the lead tab portions 111 and 112. Accordingly, when the electrode assembly 10 is disposed inside the case 130, at least a portion of the lead tab portions 111 and 112 will be disposed to protrude outward from the case 130.

The lead tab portions 111 and 112 may be formed by grouping leads 15 and 16 respectively protruding from the positive electrode and the negative electrode according to polarity and then coupling with a tab portion. In order to protect a portion where the leads 15 and 16 and the tab portion are coupled and to seal with the case 130, the battery cell 100 may include lead films (or sealants, 11 and 12) in the portion where the leads 15 and 16 and the tab portion are coupled.

Meanwhile, the case 130 may include a receiving space 150 in which the electrode assembly 10 is accommodated and a capturing space 190 for capturing gas generated during a manufacturing process of the battery cell 100.

In general, the case 130 may be formed by folding one sheet in half. To this end, the case 130 may include a first part 130a forming a portion of the sheet, and a second part 130b forming another portion of the sheet.

In addition, the first part 130a may be a rectangular sheet, and the second part 130b may also be a sheet of the same shape. That is, the first part 130a and the second part 130b may have the same size. Further, the second part 130b may extend from one corner CL of the first part 130a such that the first part 130a and the second part 130b are integrally formed. That is, the first part 130a and the second part 130b may be connected to each other at the one corner CL.

Since the first part 130a and the second part 130b are folded and joined with respect to the one corner CL, the one corner CL may be referred to as a folding line.

Meanwhile, the first part 130a may include a first recessed space 150a formed by being recessed on one surface, and a first concave space 190a formed by being recessed in the same direction as the first recessed space 150a and disposed spaced apart from the first recessed space 150a.

Similarly, the second part 130b may include a second recessed space 150b formed by being recessed in the same direction as the first recessed space 150a, and a second concave space 190b formed by being recessed in the same direction as the first recessed space 150a and disposed spaced apart from the second recessed space 150b.

When the first part 130a and the second part 130b are folded with respect to the folding line CL, the first recessed space 150a and the second recessed space 150b may form the receiving space 150.

Similarly, when the first part 130a and the second part 130b are folded with respect to the folding line CL, the first concave space 190a and the second concave space 190b may form the capturing space 190.

Before folding the first part 130a and the second part 130b, the first recessed space 150a, the second recessed space 150b, the first concave space 190a, and the second concave space 190b may all have a shape opened in the same direction.

When the first part 130a and the second part 130b are folded and joined with respect to the folding line CL, an opening of the first recessed space 150a and an opening of the second recessed space 150b overlap each other, and consequently, the first recessed space 150a and the second recessed space 150b will form one receiving space 150.

Similarly, when the first part 130a and the second part 130b are folded and joined, an opening of the first concave space 190a and an opening of the second concave space 190b overlap each other, and consequently, the first concave space 190a and the second concave space 190b will form one capturing space 190.

Meanwhile, a volume of the receiving space 150 may be greater than a volume of the capturing space 190, since the gas can also be compressed and therefore does not need to occupy a volume larger than that of the receiving space 150.

FIGS. 3A to 3E illustrate steps after the one step shown in FIG. 2.

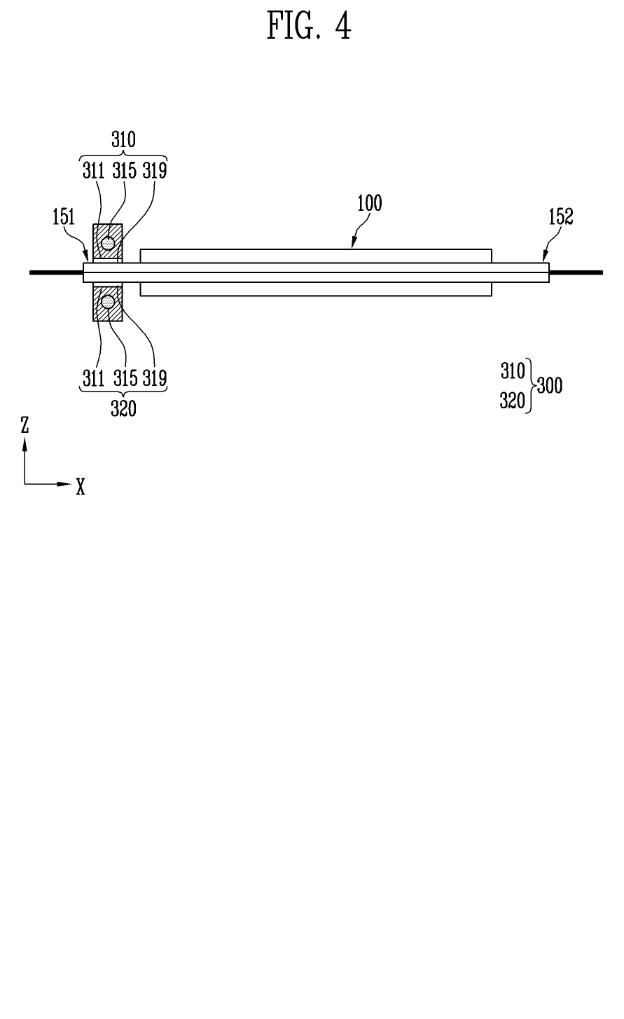

First, referring to FIG. 2, FIG. 3A, and FIG. 3B, the first part 130a and the second part 130b of the case 130 (or exterior material) may be folded around the folding line CL to form a receiving space 150 accommodating the electrode assembly 10 and a capturing space 190. The battery cell 100 may include flange portions 151a, 151b, 152a, 152b, 153a, 153b, 155a, and 155b along circumferences of the first recessed space 150a, the second recessed space 150b, the first concave space 190a, and the second concave space 190b. A battery manufacturing apparatus 300 (see FIG. 4) according to the present disclosure may seal a first sealing region 151, a second sealing region 152, a third sealing region 153, and a sealing region 155 formed on the flange portions 151a, 151b, 152a, 152b, 153a, 153b, 155a, and 155b.

Referring to FIG. 3A, after the electrode assembly 10 is disposed in the receiving space 150 of the case 130 forming the receiving space 150 and the capturing space 190, a battery manufacturing apparatus 300 according to the present disclosure may seal one region of the case 130 including a portion where the lead tab portions 111 and 112 protrude.

Since the case 130 is formed by folding the first part 130a and the second part 130b with respect to the folding line CL, in order to prevent leakage of the electrolyte EL accommodated in the receiving space 150, it will be necessary to seal regions other than the folding line CL. That is, before sealing, the case 130 will be in a form in which three sides of the case 130 are opened except for the folding line CL.

Referring to FIG. 3A, before injecting the electrolyte EL, a battery manufacturing apparatus 300 according to the present disclosure may seal a first sealing region 151 and a second sealing region 152, which are one region of the case 130 including a portion where the lead tab portions 111 and 112 protrude.

In FIG. 3A, a configuration in which the lead tab portions 111 and 112 protrude to both sides is illustrated as an example, but the lead tab portions 111 and 112 may also protrude in the same direction. In this case, the battery manufacturing apparatus 300 according to the present disclosure may also seal a first sealing region 151, which is one region of the case 130 including a portion where the lead tab portions 111 and 112 protrude, and a second sealing region 152, which is a region opposite to the first sealing region 151 with the electrode assembly 10 interposed therebetween.

When a surface facing a surface on which the electrode assembly 10 is stacked is referred to as a front surface of the case 130, the first sealing region 151 and the second sealing region 152 may be regions including left and right flanges of the front surface. That is, the electrode assembly 10 may be positioned between the first sealing region 151 and the second sealing region 152.

The first sealing region 151 will be formed by coupling and sealing of the first part 130a and the second part 130b. That is, the first sealing region 151 may be formed by portions respectively forming one flange portion 151a and 151b of the first part 130a and the second part 130b before the first part 130a and the second part 130b are folded. After one flange portion 151a and 151b of the first part 130a and the second part 130b are coupled to correspond to each other, the battery manufacturing apparatus 300 according to the present disclosure may form the first sealing region 151 through contact and heating.

Similarly, the second sealing region 152 will also be formed by coupling and sealing of the first part 130a and the second part 130b. That is, the second sealing region 152 may be formed by regions forming other flange portions 152a and 152b of the first part 130a and the second part 130b, respectively, before the first part 130a and the second part 130b are folded. After the other flange portions 152a and 152b of the first part 130a and the second part 130b are coupled to correspond to each other, the battery manufacturing apparatus 300 according to the present disclosure may form the second sealing region 152 through contact and heating.

By sealing the first sealing region 151 and the second sealing region 152, the case 130 will be in a state in which all regions are sealed except for a third sealing region 153 (see FIG. 3B) including an upper flange of the case 130.

Meanwhile, referring to FIG. 3A, after the first sealing region 151 and the second sealing region 152 are sealed, an electrolyte EL may be supplied from an upper portion of the case 130 toward the receiving space 150. The electrolyte EL may be accommodated in the receiving space 150 by a predetermined weight or a predetermined amount to immerse the electrode assembly 10. The electrode assembly 10 may be submerged in the liquid-state electrolyte EL.

Referring to FIG. 3B, after the electrolyte EL is injected into the receiving space 150, another region of the case 130 including a portion into which the electrolyte EL is injected may be sealed.

The other region is a region opened for injecting the electrolyte EL, and in the present specification, is referred to as a third sealing region 153. The third sealing region 153 may be a region including remaining flanges except for the flanges included in the first sealing region 151 and the second sealing region 152. That is, the third sealing region 153 may be a region located at an upper side of the case 130. Similar to the first sealing region 151 and the second sealing region 152, the third sealing region 153 may be formed through contact and heating.

Meanwhile, although the receiving space 150 and the capturing space 190 are in a sealed state, they may be in a state capable of communicating with each other. That is, since the case 130 is coupled and sealed along an edge thereof, in other regions of the case 130, the first part 130a and the second part 130b may simply be in contact with each other. Accordingly, the receiving space 150 and the capturing space 190 may communicate with each other. Through this, gas generated from the electrolyte EL accommodated in the receiving space 150 may move to the capturing space 190.

When sealing of the third sealing region 153 is completed, the battery cell 100 being manufactured may be charged. This may be referred to as an initial charging step.

As described above, gas may be generated from the electrolyte EL during the initial charging step. Since the case 130 is in a sealed state, the gas cannot be discharged to the outside, but may collect in the capturing space 190. That is, the capturing space 190 may be a space intentionally designed to effectively capture gas generated from the electrolyte EL.

Referring to FIG. 3C, in order to discharge gas collected in the capturing space 190 during the initial charging step, the battery cell 100 being manufactured according to the present disclosure may include a through-hole 180 penetrating a portion of the case 130.

The through-hole 180 may be provided in a plurality and may be formed by penetrating a bottom surface of the first concave space 190a and a bottom surface of the second concave space 190b.

The plurality of through-holes 180 may communicate the capturing space 190 with the outside. Accordingly, gas collected in the capturing space 190 may be discharged to the outside through the plurality of through-holes 180. This may be referred to as degassing.

Referring to FIG. 3D, after the degassing step, a battery manufacturing apparatus 300 according to the present disclosure may seal a predetermined sealing region 155 located between the receiving space 150 and the capturing space 190 in the case 130.

That is, the battery manufacturing apparatus 300 according to the present disclosure may form the sealing region 155, which is located between the receiving space 150 and the capturing space 190 and extends from the first sealing region 151 to the second sealing region 152, by contacting and heating.

Through sealing of the sealing region 155, the capturing space 190 and the receiving space 150 may be separated and isolated from each other. Similar to sealing of the first sealing region 151, the second sealing region 152, and the third sealing region 153, the sealing region 155 will also be formed after a portion 155a of the first part 130a and a portion 155b of the second part 130b corresponding to the sealing region 155 are coupled, and then pressurized or heated.

Referring to FIG. 3E, after sealing of the sealing region 155, since the capturing space 190 is no longer required to be utilized, the portion between the sealing region 155 and the capturing space 190 is cut, and through the cutting, a final shape of the battery cell 100 illustrated in FIG. 3E may be obtained.

FIG. 4 illustrates an example of a battery manufacturing apparatus according to the present disclosure.

As described with reference to FIG. 3, a battery manufacturing apparatus 300 according to the present disclosure may be used to seal various regions of the case 130.

Referring to FIG. 4, in a battery manufacturing apparatus 300 for manufacturing a battery cell 100 including a case 130 forming a receiving space 150 for accommodating an electrode assembly 10, flange portions 151a, 151b, 152a, 152b, 153a, 153b, 155a, and 155b formed along a circumference of the receiving space 150 in the case 130, and sealing regions 151, 152, 153, and 155 sealing at least a portion of the flange portions 151a, 151b, 152a, 152b, 153a, 153b, 155a, and 155b, the battery manufacturing apparatus 300 according to the present disclosure may include: a first sealing bar 310 and a second sealing bar 320 disposed to face each other across the sealing regions 151, 152, 153, and 155 so as to contact the sealing regions 151, 152, 153, and 155 and extending along a predetermined extending direction parallel to one side of the receiving space 150; a first sealing surface 311 among one surface of the first sealing bar 310, the first sealing surface facing the sealing regions 151, 152, 153, and 155; a second sealing surface 321 among one surface of the second sealing bar 320, the second sealing surface facing the sealing regions 151, 152, 153, and 155 and the first sealing surface 311; a film-shaped first heating portion 319 disposed on the first sealing surface 311; and a film-shaped second heating portion 329 disposed on the second sealing surface 321.

The sealing regions 151, 152, 153, and 155 may be any one or a combination of the first sealing region 151, the second sealing region 152, the third sealing region 153, and the sealing region 155. For example, FIG. 4 illustrates the first sealing region 151 and the second sealing region 152 among them.

The first sealing bar 310 and the second sealing bar 320 may be bar-shaped members. For example, the first sealing bar 310 and the second sealing bar 320 may have a rectangular parallelepiped shape. Accordingly, since the first sealing surface 311 and the second sealing surface 321 are planar shapes, they may uniformly contact and pressurize the sealing regions 151, 152, 153, and 155.

The first heating portion 319 may be disposed on the first sealing surface 311. Similarly, the second heating portion 329 may be disposed on the second sealing surface 321. Accordingly, the first heating portion 319 and the second heating portion 329 may be disposed to correspond to each other so as to face each other across the sealing regions 151, 152, 153, and 155.

The first heating portion 319 and the second heating portion 329 may be thin-film heaters or thick-film heaters provided in a film form. For example, the first heating portion 319 and the second heating portion 329 may be a surface heating element in which a carbon heating element is applied to a thin film, electrodes are formed of copper foil, and then laminated with a film.

Meanwhile, the battery manufacturing apparatus 300 according to the present disclosure may further include a first temperature sensor 315 disposed on the first sealing bar 310 and configured to sense a temperature of the first heating portion 319, and a second temperature sensor 325 disposed on the second sealing bar 320 and configured to sense a temperature of the second heating portion 329.

The first temperature sensor 315 and the second temperature sensor 325 may be positioned anywhere as long as they can accurately measure the temperatures of the first heating portion 319 and the second heating portion 329, respectively.

In one embodiment, the first temperature sensor 315 and the second temperature sensor 325 may be thermocouples. However, this is only an example, and a temperature sensing method of the first temperature sensor 315 and the second temperature sensor 325 is not limited thereto.

In one embodiment, the first temperature sensor 315 may be inserted into the first sealing bar 310 spaced apart by a predetermined distance from the first sealing surface 311, and the second temperature sensor 325 may be inserted into the second sealing bar 320 spaced apart by the predetermined distance from the second sealing surface 321.

Through this, the first temperature sensor 315 and the second temperature sensor 325 may more accurately measure a temperature of the sealing regions 151, 152, 153, and 155 or a temperature of the first heating portion 319 and the second heating portion 329 by contacting the first heating portion 319 and the second heating portion 329 among the sealing regions 151, 152, 153, and 155.

Meanwhile, in a battery manufacturing apparatus 300 for manufacturing a battery cell 100 including a case 130 forming a receiving space 150 for accommodating an electrode assembly 10, flange portions 151a, 151b, 152a, 152b, 153a, 153b, 155a, and 155b formed along a circumference of the receiving space 150 in the case 130, and sealing regions 151, 152, 153, and 155 sealing at least a portion of the flange portions 151a, 151b, 152a, 152b, 153a, 153b, 155a, and 155b, the battery manufacturing apparatus 300 according to the present disclosure may include: a first sealing bar 310 and a second sealing bar 320 disposed to face each other across the sealing regions 151, 152, 153, and 155 so as to contact the sealing regions 151, 152, 153, and 155; a first sealing surface 311 among one surface of the first sealing bar 310, the first sealing surface facing the sealing regions 151, 152, 153, and 155; a second sealing surface 321 among one surface of the second sealing bar 320, the second sealing surface facing the sealing regions 151, 152, 153, and 155 and the first sealing surface 311; and a film-shaped heating portion 319, 329 disposed on at least one of the first sealing surface 311 or the second sealing surface 321.

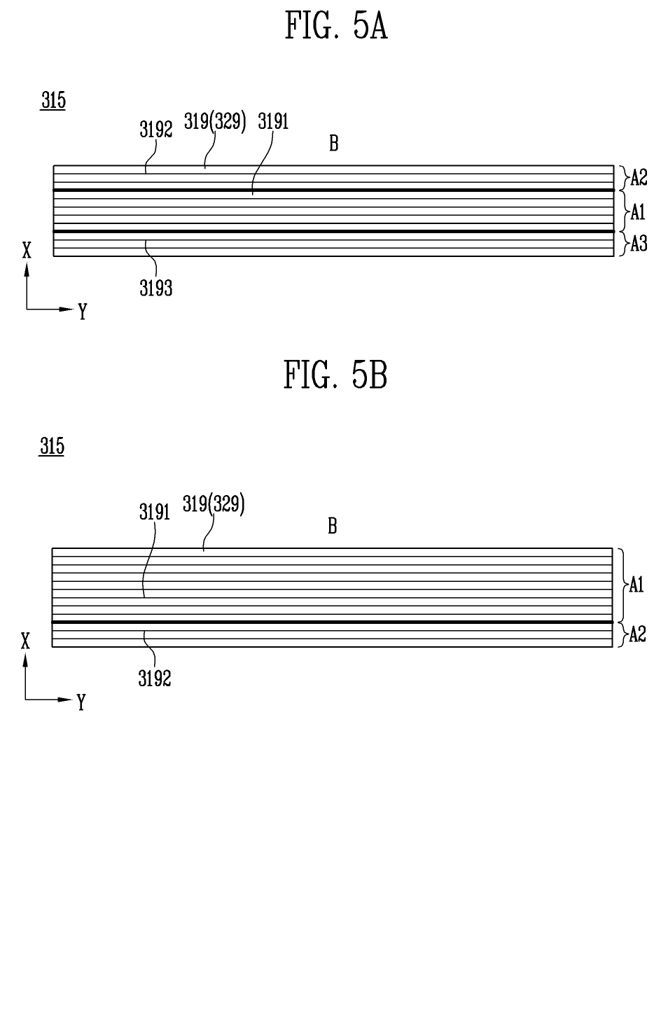

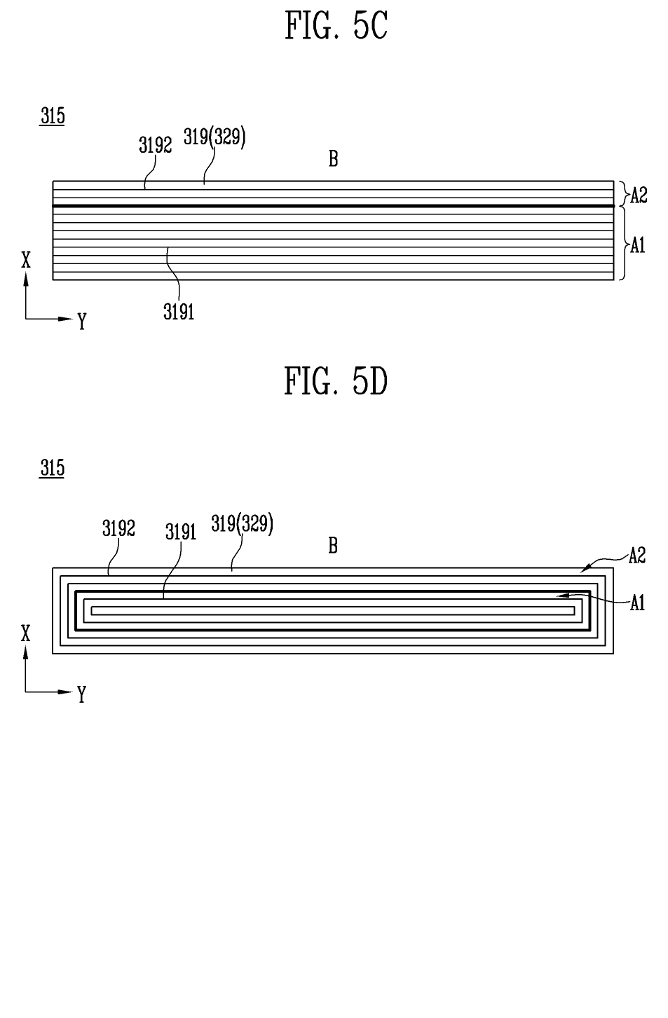

FIGS. 5A to 5D illustrate various embodiments of a heating portion.

More specifically, FIGS. 5A to 5D illustrate various embodiments of the first heating portion 319 when viewed toward the first sealing surface 311. In addition, in order to indicate a relative position of the battery cell 100 and the heating portions 319 and 329, a direction in which the battery cell is positioned is indicated as direction B.

Referring to FIG. 5A, the first heating portion 319 may include a first heater 3191 disposed in a predetermined first region A1 on the first sealing surface 311, and a second heater 3192 and a third heater 3193 respectively disposed in a second region A2 and a third region A3 formed on the first sealing surface 311 across the first region A1.

The first heater 3191 and the second heater 3192, or the first heater 3191 and the third heater 3193, may be positioned adjacent to each other or spaced apart from each other.

In addition, the first heater 3191, the second heater 3192, and the third heater 3193 may be respectively extended along the extending direction.

In addition, the first heater 3191, the second heater 3192, and the third heater 3193 may be respectively provided in a plurality.

In one embodiment, the first heater 3191, the second heater 3192, and the third heater 3193 may be heated at different temperatures.

That is, the first heater 3191, the second heater 3192, and the third heater 3193 may operate independently.

Referring to FIG. 5B, the first heating portion 319 may include a first heater 3191 disposed in a predetermined first region A1 on the first sealing surface 311, and a second heater 3192 disposed in a second region A2 on the first sealing surface 311 located closer to the receiving space 150 than the first region A1.

In addition, referring to FIG. 5C, the first heating portion 319 may include a first heater 3191 disposed in a predetermined first region A1 on the first sealing surface 311, and a second heater 3192 disposed in a second region A2 on the first sealing surface 311 located farther from the receiving space 150 than the first region A1.

In addition, the first heater 3191 and the second heater 3192 may be respectively extended along the extending direction.

In addition, the first heater 3191 and the second heater 3192 may be respectively provided in a plurality.

In addition, the first heater 3191 and the second heater 3192 may be heated at different temperatures.

Referring to FIG. 5D, the first heating portion 319 may include a first heater 3191 disposed in a predetermined first region A1 on the first sealing surface 311, and a second heater 3192 disposed in a second region A2 located along a circumference of the first region A1 on the first sealing surface 311.

That is, the first heater 3191 and the second heater 3192 may be provided in the same shape but may differ only in size.

A pattern of the first heater 3191 in the first heating portion 319 may be various. The pattern of the first heater 3191 may also be implemented through printing of a predetermined image. This may be similarly applied to the pattern of the second heater 3192 and the pattern of the third heater 3193.

In the present specification, the description of the first heating portion 319 may be equally applied to the second heating portion 329 unless otherwise specified.

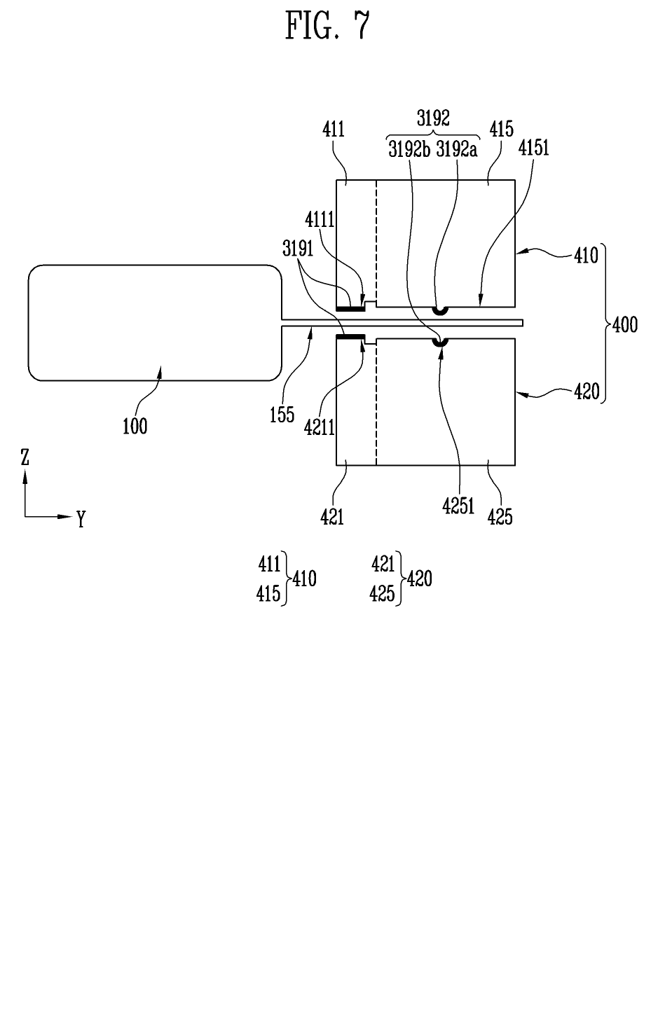

Meanwhile, the patterns of the first heater 3191 and the second heater 3192 illustrated in FIGS. 5A to 5C may also be equally applied to the battery manufacturing apparatus 400 illustrated in FIG. 7.

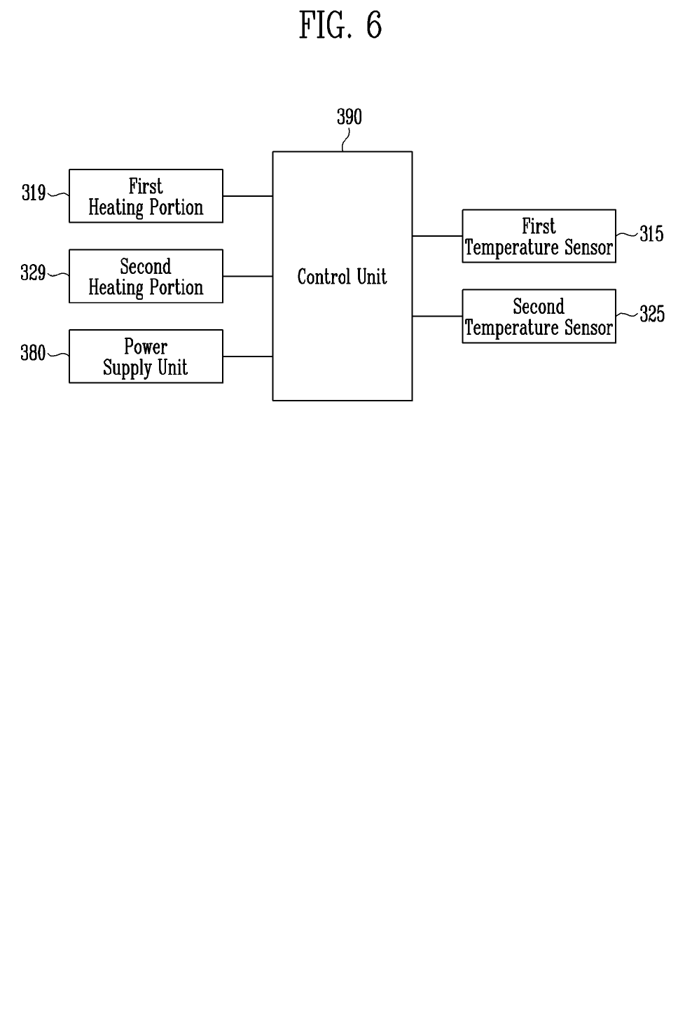

FIG. 6 illustrates a control block diagram of a battery manufacturing apparatus according to the present disclosure.

The battery manufacturing apparatus 300 according to the present disclosure may include a control unit 390. The control unit 390 may control the first heating portion 319 and the second heating portion 329. In addition, the control unit 390 may control the first temperature sensor 315 and the second temperature sensor 325, and when the first heating portion 319 and the second heating portion 329 reach a predetermined target temperature, the control unit 390 may control a power supply unit 380 to cut off power supply.

Meanwhile, a control block diagram of the battery manufacturing apparatus 300 illustrated in FIG. 6 may also be equally applied to a control block diagram of the battery manufacturing apparatus 400 illustrated in FIG. 7.

FIG. 7 illustrates another example of a battery manufacturing apparatus according to the present disclosure.

The film-shaped first heating portion 319 and the second heating portion 329 may be applied not only to the battery manufacturing apparatus 300 but also to a battery manufacturing apparatus 400 that forms in advance a portion to be folded before folding a part of the flange portions 155a and 155b.

The film-shaped first heating portion 319 and the second heating portion 329 may refer to the battery manufacturing apparatus 300 as a battery sealing apparatus (or a first battery manufacturing apparatus), and the battery manufacturing apparatus 400 that forms in advance a portion to be folded before folding a part of the flange portions 155a and 155b may also be referred to as a battery folding apparatus (or a second battery manufacturing apparatus). That is, FIGS. 1 to 6 illustrate an example of the battery manufacturing apparatus 300 also called a battery sealing apparatus, and FIG. 7 illustrates another example of the battery manufacturing apparatus 400 also called a battery folding apparatus.

Referring to FIG. 3E, after the portion between the sealing region 155 and the capturing space 190 is cut, in order to prevent the case 130 at the cut portion from opening, the cut portion may be folded inward.

For this purpose, referring to FIG. 7, in a battery manufacturing apparatus 400 for manufacturing a battery cell 100 including a case 130 forming a receiving space 150 for accommodating an electrode assembly 10, and flange portions 155a and 155b formed along a circumference of the receiving space 150 in the case 130, the battery manufacturing apparatus 400 according to the present disclosure may include a first bending body 410 and a second bending body 420 that contact the flange portions 155a and 155b with the flange portions 155a and 155b interposed therebetween to bend at least a portion of the flange portions 155a and 155b.

In addition, the first bending body 410 and the second bending body 420 may respectively include: block bodies 411 and 421 that are movable toward the flange portions 151a, 151b, 152a, 152b, 153a, 153b, and 155a, 155b; unit bodies 415 and 425 that are disposed in a direction away from the receiving space 150 relative to the block bodies 411 and 421 and are movable toward the flange portions 151a, 151b, 152a, 152b, 153a, 153b, and 155a, 155b; film-shaped first heating portions 319 disposed on block contact surfaces 4111 and 4211 among surfaces of the block bodies 411 and 421, the block contact surfaces being in contact with the flange portions 151a, 151b, 152a, 152b, 153a, 153b, and 155a, 155b; and film-shaped second heating portions 329 disposed on unit contact surfaces 4151 and 4251 among surfaces of the unit bodies 415 and 425, the unit contact surfaces being in contact with the flange portions 151a, 151b, 152a, 152b, 153a, 153b, and 155a, 155b.

The block bodies 411 and 421 and the unit bodies 415 and 425 may be in contact with each other, but the first heating portion 319 and the second heating portion 329 may be disposed to be spaced apart from each other.

Accordingly, the first heating portion 319 and the second heating portion 329 may heat the flange portions 155a and 155b at different temperatures to form different grooves.

Referring to FIG. 7, the first heating portion 319 may be disposed on a portion of each block contact surface 4111 and 4211 of the first bending body 410 and the second bending body 420. And, in a direction away from the battery cell 100, an adjacent portion of the first heating portion 319 may form a recessed portion into the inside of each of the block bodies 411 and 421.

The first bending body 410 may include a convex portion 4151 formed such that a part of the unit body 415 of the first bending body 410 protrudes convexly toward the second bending body 420. In addition, the second bending body 420 may include a concave portion 4252 formed such that a part of the unit body 425 of the second bending body 420 is recessed into the inside of the second bending body 420 in correspondence with the convex portion 4151. The second heating portion 329 may be respectively disposed in the convex portion 4151 and the concave portion 4252.

Due to the recessed portion adjacent to the first heating portion 319 and the convex portion 4151 and the concave portion 4252, a folding line in a predetermined pattern may be formed on the flange portions 155a and 155b located outside the sealing region 155. Through this, compared with when using a general heater, the battery manufacturing apparatus 400 may form the folding line with a finer width through the film-shaped first heating portion 319 and the second heating portion 329.

A heater pattern of the first heating portion 319 and the second heating portion 329 may be any one of the various embodiments illustrated in FIGS. 5A to 5C.

Meanwhile, a battery manufacturing system 1000 according to the present disclosure may include the battery sealing apparatus and the battery folding apparatus.

The present disclosure may be embodied in various forms, and the scope of rights thereof is not limited to the above-described embodiments. Therefore, if a modified embodiment includes elements of the claims of the present disclosure, it should be construed as belonging to the scope of rights of the present disclosure.

What is claimed is:

1. A battery manufacturing apparatus for manufacturing a battery cell, comprising:
a first sealing bar and a second sealing bar disposed to face each other across a sealing region of the battery cell so as to contact the sealing region and extending along a predetermined extending direction parallel to one side of a receiving space of the battery cell;
a first sealing surface among one surface of the first sealing bar, the first sealing surface facing the sealing region;
a second sealing surface among one surface of the second sealing bar, the second sealing surface facing the sealing region and the first sealing surface;
a film-shaped first heating portion disposed on the first sealing surface; and
a film-shaped second heating portion disposed on the second sealing surface;
wherein the battery cell comprises a case forming the receiving space for receiving an electrode assembly, a flange portion formed along a circumference of the receiving space in the case, and the sealing region sealing at least a portion of the flange portion.

2. The battery manufacturing apparatus according to claim 1, wherein the first heating portion comprises:
a first heater disposed in a predetermined first region on the first sealing surface; and
a second heater and a third heater respectively disposed in a second region and a third region formed on the first sealing surface across the first region.

3. The battery manufacturing apparatus according to claim 2, wherein the first heater, the second heater, and the third heater are respectively extended along the extending direction.

4. The battery manufacturing apparatus according to claim 2, wherein the first heater, the second heater, and the third heater are respectively provided in a plurality.

5. The battery manufacturing apparatus according to claim 2, wherein the first heater, the second heater, and the third heater are capable of being heated at different temperatures.

6. The battery manufacturing apparatus according to claim 1, wherein the first heating portion comprises:
a first heater disposed in a predetermined first region on the first sealing surface; and
a second heater disposed in a second region located closer to the receiving space than the first region on the first sealing surface.

7. The battery manufacturing apparatus according to claim 6, wherein the first heater and the second heater are respectively extended along the extending direction.

8. The battery manufacturing apparatus according to claim 6, wherein the first heater and the second heater are respectively provided in a plurality.

9. The battery manufacturing apparatus according to claim 6, wherein the first heater and the second heater are capable of being heated at different temperatures.

10. The battery manufacturing apparatus according to claim 1, wherein the first heating portion comprises:
a first heater disposed in a predetermined first region on the first sealing surface; and
a second heater disposed in a second region located farther from the receiving space than the first region on the first sealing surface.

11. The battery manufacturing apparatus according to claim 10, wherein the first heater and the second heater are respectively extended along the extending direction.

12. The battery manufacturing apparatus according to claim 10, wherein the first heater and the second heater are respectively provided in a plurality.

13. The battery manufacturing apparatus according to claim 10, wherein the first heater and the second heater are capable of being heated at different temperatures.

14. The battery manufacturing apparatus according to claim 1, wherein the first heating portion comprises:
a first heater disposed in a predetermined first region on the first sealing surface; and
a second heater disposed in a second region located along a circumference of the first region on the first sealing surface.

15. The battery manufacturing apparatus according to claim 1, further comprising:
a first temperature sensor disposed on the first sealing bar and configured to sense a temperature of the first heating portion; and
a second temperature sensor disposed on the second sealing bar and configured to sense a temperature of the second heating portion.

16. The battery manufacturing apparatus according to claim 15, wherein the first temperature sensor and the second temperature sensor are thermocouples.

17. The battery manufacturing apparatus according to claim 15, wherein the first temperature sensor is inserted into the first sealing bar spaced apart by a predetermined distance from the first sealing surface, and
the second temperature sensor is inserted into the second sealing bar spaced apart by the predetermined distance from the second sealing surface.

18. A battery manufacturing apparatus for manufacturing a battery cell, comprising:
a first sealing bar and a second sealing bar disposed to face each other across a sealing region of the battery cell so as to contact the sealing region;
a first sealing surface among one surface of the first sealing bar, the first sealing surface facing the sealing region;
a second sealing surface among one surface of the second sealing bar, the second sealing surface facing the sealing region and the first sealing surface; and
a film-shaped heating portion disposed on at least one sealing surface of the first sealing surface or the second sealing surface;
wherein the battery cell comprises a case forming the receiving space for receiving an electrode assembly, a flange portion formed along a circumference of the receiving space in the case, and the sealing region sealing at least a portion of the flange portion.

19. A battery manufacturing apparatus for manufacturing a battery cell, comprising:
a first bending body and a second bending body disposed to contact a flange portion of the battery cell across the flange portion to bend at least a portion of the flange portion; wherein the first bending body and the second bending body respectively comprise:
a block body movable toward the flange portion;
a unit body disposed in a direction farther from a receiving space of the battery cell than the block body and movable toward the flange portion;
a film-shaped first heating portion disposed on a block contact surface among one surface of the block body, the block contact surface contacting the flange portion; and
a film-shaped second heating portion disposed on a unit contact surface among one surface of the unit body, the unit contact surface contacting the flange portion;
wherein the battery cell comprises a case forming the receiving space for receiving an electrode assembly, and a flange portion formed along a circumference of the receiving space in the case.
